(19) United States
(12) Patent Application Publication
(10) Pub. No.: US 2025/0260948 A1
(43) Pub. Date: Aug. 14, 2025

(54) CALIBRATION OF RADIOFREQUENCY SYSTEM POSITION USING COMPUTER VISION TO ESTABLISH TRUE POSITIONS FOR VERIFYING RADIO SIGNAL INTEGRITY AND SCREEN MULTIPATH AND/OR RELATED SIGNAL INTERFERENCE SOURCES

(71) Applicant: Position Imaging, Inc., Portsmouth, NH (US)

(72) Inventors: Edward L. Hill, Conway, NH (US); Narasimhachary Nallana Chakravarty, Rollinsford, NH (US); Guohua Min, Exeter, NH (US)

(21) Appl. No.: 19/052,753

(22) Filed: Feb. 13, 2025

Related U.S. Application Data
(60) Provisional application No. 63/552,852, filed on Feb. 13, 2024.

(51) Int. Cl. H04W 4/029; G06T 7/70

(52) U.S. Cl. CPC H04W 4/029; G06T 7/70; G06T 2207/10028

(57) ABSTRACT

A radio system tracking can automate the tracking of an electronic tag device (ETD) by identifying the ETD's signal identifier and then perform a tracking function to determine a general position of the ETD. Over time, as the ETD moves and a computer vision system monitors and tracks the device location, the radio position tracking of the ETD and the computer vision position tracking of the ETDs will eventually converge and the computer vision can then determine that the ETD in the camera view is the same ETD communicating with the radio tracking system. Once this convergence occurs and the computer vision system can determine the ETD position, the radio system can use this now known ETD position to calibrate the position calculation calculated by the radio system and screen signals that would not be possible from positions other than the position determined by the computer vision system.

### RELATED APPLICATIONS

This application claims priority to U.S. provisional application No. 63/552,852, filed Feb. 13, 2024 and entitled “Passive Radio Frequency Identification with Computer Vision Tracking, the entirety of which is incorporated by reference herein.

### FIELD OF THE INVENTION

The invention relates generally to wireless tracking of objects, and more specifically to a calibrating routine for identifying a position of multiple objects at a location of interest.

### BACKGROUND

The tracking of objects, or more specifically the delivery of packages such as letters, containers, and boxes of any shape and size, entails complex logistics.

Most package shippers currently use barcode labels, tags, or the like on packages to track movement of the packages through their delivery system. Each barcode stores information about its package; such information may include the dimensions of the package, its weight and destination. When shipping personnel pick up a package, he or she scans the barcode to sort the package appropriately. The delivery system uses this scanned information to track the movements of the package. Upon arriving at a final destination, a package rolls off a truck or plane on a roller belt. Personnel such as a delivery driver uses a barcode reader to scan the package, and the system recognizes that the package is at the destination.

Even at the final destination, there may be a desire to track assets such as delivered packages. Some systems employ video monitoring and image processing technology to identify what items a person such as a delivery driver or customer has taken from or placed on a shelf. As artificial intelligence continues to evolve, computer vision is also available by using digital images from cameras, videos, or other visual sensors, to identify and locate objects, perform facial recognition, and detect and tracking the movement of people and/or objects in video frames.

Another tracking technology includes the use of radio frequency identification (RFID) chips on the packages. However, tracking only using RFID technology may not satisfy the requirement of high accuracy, with respect to estimating the actual position of a tracked object. Also, when RFID tracking is performed, some environments may experience multipath and interference issues when using received signal strength indicator (RSSI), angle of arrival (AoA), time difference of arrival (TDoA), etc. for locating objects such as packages For example, the multipath waves of an RF signal exchanged between a reader and a passive RFID tag can reflect and cause interference and bad readings. It is desirable to use each technology's (computer vision and RFID) tracking information to achieve better visibility and identification of assets but without two disparate and hardware-intensive tracking systems.

### SUMMARY

There are many applications that utilize radio communications to determine location of mobile devices or electronic tags that are attached to objects that are communicating with the system. The body of the patent will refer to these devices that are attached to or otherwise associated with objects of interest for which there is a desire to perform tracking as electronic tag devices (ETDs), these could be passive and active NFC, RFID, Bluetooth™ Low Energy (BLE) tags all the way out to smart phone devices. The radio systems typically consist of a network of radio receivers, communicating with EDTs, to determine the position of these ETDs. The system can employ several approaches for determining position; received signal strength from the ETD, time of arrival or time difference of arrival of the ETD's signal at two or more network receivers, or angle of arrival of the ETD's signals as received by the system's network receiver(s) antenna(s). In all of these tracking approaches, the integrity of the signal determines the accuracy of the ETD's position calculation.

In all radio communications systems, interference is always present and can corrupt the signals received by the network. This interference can be caused by multipath or multiple signal paths from the ETD to the network receivers, when the ETD signals reflect off objects, walls, etc. and arrive later or with less strength at the network receivers. When the network confuses a longer path received from the ETD with the shorter, more direct path from the ETD, the accuracy of the ETD position would be corrupted. In this case, the longer path from the ETD would deliver a lower signal strength at the system network. If the system utilized signal strength to determine the position of the ETD, then the longer signal path would imply a further distance of the ETD from the radio receivers, causing position calculation to be corrupted and not accurate. If there was a way to determine where the ETD was located when it was transmitting its signal to the radio tracking network receiver(s), the system could screen the erroneous signal paths caused by multipath. The system would do this screening by correlating the ETD position to the radio system receivers' location and estimate the appropriate signal strength from the ETD to the receiver location. Signals received by the network receivers from the ETD that are not within the expected signal strength, as determined by the system's knowledge of the ETD relative position to the network receivers, could be ignored, improving the system's calculation of the ETD's position.

If the system could determine where the ETDs are located through computer vision, the system could then screen the signals from that specific ETD that do not match what signals would be expected, e.g., signal strength, time or arrival, time difference of arrival, and angle of arrival, and so on, at the network receivers. The computer vision system can establish a calibration template for the radio system such that the ETDs communicating with the system are fixed and known, providing a means to limit the multipath interference and improve the system's accuracy of the ETD's position.

Since the radio system and computer vision need to work together, the radio system tracking can automate the tracking of the ETD(s) by identifying the ETD signal ID and then perform a tracking function to determine a general position of the ETD. Over time, as an ETD moves and the computer vision system monitors and tracks the device location, the radio position tracking of the ETD and the computer vision position tracking of the ETD, and possibly the tracking of other ETDs along with the ETD, will eventually converge and the computer vision can then determine that the ETD(s) in the camera view is the same ETD communicating with the radio tracking system. Once this convergence occurs and the computer vision system can determine the ETD's position, the radio system can use this now known ETD position to calibrate the position calculation calculated by the radio system and screen signals that would not be possible from positions other than the position determined by the computer vision system.

Various embodiments of the present inventive concept leverage a 3D calibration grid to establish signal characteristics under controlled conditions and in real-world environments. In the first set of embodiments, a set of strategically positioned electronic tag devices (ETDs) is arranged around one or more reader devices in a noise-free, ideal environment. This initial calibration captures baseline signal levels and quality at known ETD positions. The collected data is processed through algorithms to develop predictive models and equations that define expected signal behaviors under optimal conditions. The calibration grid is then deployed in the actual area of operation, where the same process is repeated. In this environment, factors such as multipath interference and noise affect the signals. Comparing these measurements against the noise-free baseline enables the generation of models that characterize and compensate for environmental distortions. These models allow the system to correct signal levels and refine position calculations when ETD positions are known. The readers in this embodiment can be RFID readers, BLE beacons, or other radio receivers, and they may use single or multiple antennas, including phased arrays. Depending on the antenna configuration, various signal parameters such as received signal strength indicator (RSSI), angle of arrival (AoA), time of arrival (ToA), and time difference of arrival (TDoA) can be captured, further enhancing the accuracy of position determination and interference correction.

In a second set of embodiments, instead of using a fixed calibration grid of ETDs, a mobile ETD is moved either in a predefined pattern or randomly around the reader(s) in both the noise-free calibration environment and the real-world operational setting. This approach eliminates the need for multiple ETDs to be precisely placed, reducing setup complexity while still generating the necessary signal quality and multipath interference data. By tracking the moving ETD's position at each step, the system can develop a detailed signal response model across various locations. These measurements, once analyzed, provide a dynamic calibration framework that can be applied to refine the radio tracking system's position calculations. The corrective models and equations generated in these embodiments can incorporate various signal processing techniques to enhance positional accuracy. If the ETD's position is known, techniques such as regression analysis, machine learning-based prediction models, and Kalman filtering can be used to establish relationships between ideal and real-world signal behaviors. Multipath mitigation techniques, such as ray tracing-based corrections, adaptive filtering, and deep learning models trained on signal distortions, can be employed to adjust erroneous signal measurements dynamically. Additionally, physics-based modeling of radio wave propagation can be used to generate environmental correction coefficients, enabling real-time compensation for multipath interference. These equations and models form the foundation for a self-calibrating positioning system that continuously adapts to environmental conditions, improving the reliability ETDs location tracking.

Another critical aspect of signal correction in real-world environments is occlusion modeling. Once the system establishes baseline signal characteristics in the area of operation without obstructions-such as human operators or robotic systems-it can then re-capture signal data under operational conditions where people and robots are present. Using the same calibration techniques described above, the system can identify how occlusions impact signal strength, angle of arrival (AoA), time of arrival (ToA), time difference of arrival (TDoA), and other key parameters. By analyzing signal distortions introduced by occlusions at different positions, the system can develop correction models that account for human or robotic interference. These models can use machine learning approaches, statistical filtering, or ray-tracing simulations to estimate expected deviations and dynamically adjust position calculations. Furthermore, if the locations of the occluding objects are known through computer vision or another tracking method, the system can integrate this data into its calibration framework, refining signal correction models in real-time and mitigating occlusion-induced errors.

In one aspect, a system for tracking an object, comprises an electronic tag device (ETD) affixed to the object; one or more readers that receive signal measurements from the electronic tag device (ETD); one or more vision sensors that track the object and generate a location of the object in the image data representing a position of the at least one electronic tag device (ETD) and/or the object in a field of view; and a special-purpose processor that receives the signal measurements and the image data and applies a calibration algorithm to predict an accurate signal measurement adjusted based on the location of the object, wherein the special-purpose processor further determines a true position from the image data and correlates the true position with the signal measurements received by the one or more readers to refine the position estimation of the electronic tag device (ETD).

In another aspect, a method for calibrating a system for tracking an object comprises positioning a set of electronic tag devices (ETDs) in a structured calibration grid at predefined locations around one or more reader(s) in a controlled, noise-free environment; capturing initial signal measurements from the ETDs using the one or more reader(s); applying a calibration routine to establish baseline signal characteristics for each ETD position; relocating the calibration grid to an operational environment; capturing new signal measurements from the ETDs in the operational environment; comparing the operational signal measurements to the baseline signal characteristics to model environmental effects such as multipath interference and noise; and using the modeled environmental effects to generate correction factors for refining future signal measurements received by the one or more reader(s) when tracking objects.

In another aspect, a method for calibrating a system for tracking an object comprises capturing signal measurements from an electronic tag device (ETD) at each position of a plurality of positions; applying a calibration routine to generate a dynamic signal response model based on position-dependent variations of the plurality of positions; capturing signal measurements affected by multipath interference and noise; comparing the operational signal measurements to the dynamic signal response model to generate environmental correction factors; and applying the correction factors to refine future signal measurements when tracking objects.

In another aspect, a method for calibrating a system for tracking an object comprises moving an electronic tag device (ETD) through predefined positions around one or more readers in a controlled, noise-free environment; capturing signal measurements from the electronic tag device (ETD) at each position using the one or more reader(s); applying a calibration routine to generate a dynamic signal response model based on position-dependent variations; repeating the movement of the electronic tag device (ETD) in an operational environment; capturing signal measurements affected by multipath interference and noise; comparing the operational signal measurements to the dynamic signal response model to generate environmental correction factors; and applying the correction factors to refine future signal measurements when tracking objects.

In some embodiments, the one or more vision sensors track the movement of the electronic tag device (ETD) and map its position to a reference coordinate system to improve calibration accuracy.

In another aspect, a method for calibrating a system for tracking an object in an operational environment with occlusions, comprises capturing baseline signal measurements from electronic tag devices (ETDs) in an environment without obstructions; capturing additional signal measurements while introducing occluding objects such as humans or robots in the environment; determining deviations in signal characteristics caused by occlusions; applying a modeling technique to learn occlusion-induced signal distortions based on occluder positions and movements; and generating correction factors that dynamically adjust future signal measurements based on detected occlusions.

In another aspect, a method for calibrating a system for tracking an object using multiple vision sensors and multiple readers, comprises capturing signal measurements from electronic tag devices (ETDs) using multiple readers; capturing positional data of the ETDs using multiple vision sensors; mapping each ETD's pixel coordinates in the vision sensors to a shared reference coordinate system; collecting signal measurements from each reader in relation to the known positions of the ETDs; training a machine learning model with the ETD positions and corresponding signal measurements to learn relationships between environment-induced distortions and expected signal behavior; and using the trained machine learning model to predict corrected signal measurements in real-time during tracking operations.

In some embodiments, the one or more vision sensors include depth sensors that capture 3D spatial data of the environment to refine position estimation. In some embodiments, the machine learning model is a graph neural network (GNN) trained on signal strength (RSSI), angle of arrival (AoA), and time difference of arrival (TDoA) features to learn the environmental distortions affecting signal propagation. In other embodiments, the machine learning model is a transformer-based spatiotemporal model trained on historical signal measurements and ETD positions to dynamically adjust position calculations based on real-time data.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a diagram illustrating an environment in which embodiments of the present inventive concept are practiced.

FIGS. 2A, 2B and 2C are views of a signal exchange between an RFID reader and two RFID labels in which embodiments of the present inventive concept are practiced.

FIG. 3 is a block diagram of a system for tracking objects using a combination of computer vision and RFID-based tracking, in accordance with some embodiments.

FIG. 4 is a diagram illustrating the computer vision system of FIG. 3 calibrating the position of an RFID tag, in accordance with some embodiments.

FIG. 5 is a table of different Received Signal Strength Indicator (RSSI) readings received by two antennae of a receiver

FIG. 6 is a flow diagram of a method for calibration, in accordance with some embodiments.

### DETAILED DESCRIPTION

In brief overview, embodiments of the present inventive concept combines, or “fuses” two wireless tracking approaches, radio tracking and computer vision for tracking operations. Computer vision can be used to assist an RFID reader in determining a viable direct signal from a tracked RFID device. In particular, the computer vision is used to build, or “map” an environment to assist with multipath and occlusion-related issues in the RF domain and to understand where RF tracking readers are and perform a calibration operation to better determine the direct signals of a multipath environment between readers and RFID labels, tags, markers, QR codes, or the like attached to objects being tracked while in presence of the readers.

A reader can exchange data with radio frequency identification (RFID) tags, labels, or other electronic mobile devices (ETDs) employing RFID technology that are placed on objects such as boxes, products, shelves, etc. The RFID devices, markers, or the like can be employed as reference points at various fixed locations on a shelf or other location of interest and are used to calibrate the location estimation of objects to which the tags are attached or otherwise associated with. The computer vision feature is used to establish known a position point on a RFID tag, marker, or related elements, then execute a special-purpose calibration routine computer program to screen the multipath signals exchanged by the radio tracking exchange between reader and RFID tags by distinguishing a direct path between the reader and tag from other RF waves transmitted by the reader's antenna such as reflection, refraction diffraction and absorption or RF waves reflected or retransmitted by the tag. The calibration routine can also distinguish RF waves creating a null spot due to destructive interference. In doing so, the computer vision system can verify the position of a tracked object and improve the robustness of the desired signals exchanged with the RFID tag. In doing so, the system comprising the RFID reader, tags, and computer vision system cameras and the like can model an entire multipath environment such as a room, warehouse, an interior of a delivery vehicle, or other area where items of interest are placed and where it is desirable to track the items by collecting the position-related data from all RFID tags in the environment simultaneously, and providing the results to a machine learning model or the like. For example, embodiments of the calibration routine may be applied to an environment where a person walking in and out of the environment, e.g., a room, is modeled by the computer vision system, and in doing so, the system knows where the person is in the space, as well as the signal quality of each tag in the space. This can assist with model occlusion, so if the person is in a position, then the signal quality, e.g., RSSI, may be affected by a calculated value, and this adjustment can be captured by the calibration system.

Furthermore, the system can track a mobile ETD as it moves through the area of operation, continuously measuring its signal characteristics at various locations. By capturing signal strength, angle of arrival (AoA), time of arrival (ToA), time difference of arrival (TDoA), and other relevant parameters, the system can generate a comprehensive dataset that accounts for environmental factors such as multipath interference, occlusions, and signal attenuation. This dataset can then be used to develop regression models, neural networks, or other machine learning-based prediction models to estimate the expected signal strength at any given position. By correlating real-time signal measurements with the known position of the ETD—established through computer vision or prior calibration—the system can dynamically correct signal distortions and improve location accuracy. Additionally, occlusion effects from humans or robots within the area of operation can be incorporated into these models, enabling real-time signal corrections based on the presence and movement of obstructions. This embodiment allows for an adaptive, self-calibrating positioning system that enhances tracking accuracy across various operational environments, such as warehouses, manufacturing facilities, or delivery vehicles.

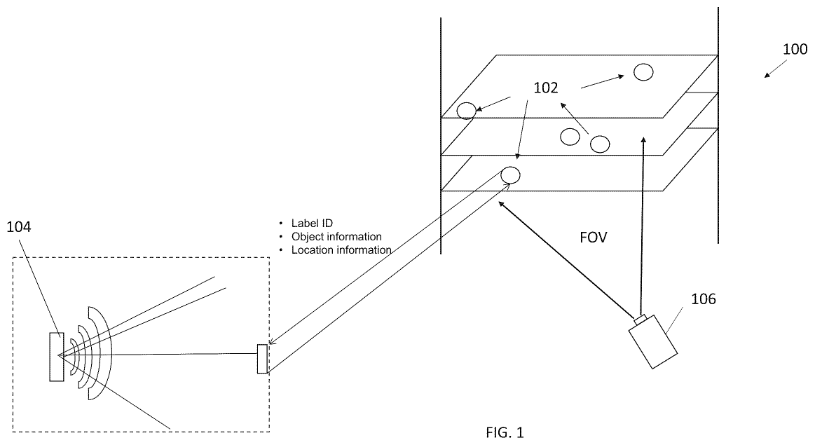

FIG. 1 illustrates a system 100 including an RFID reader 104 performing a signal exchange with at least one RFID device 102. In operation, the RFID reader 104 can communicate with all RFID devices 102 shown in FIG. 1. The RFID devices 102 may each include a computer microchip and at least one antenna. The chip stores data, such as an identification number, information about an object to which it is attached, and so on. The RFID device 102 may be constructed and arranged as a label, tag, or other small mobile electronic device with a footprint that permits the device 102 to be attached to packages, objects, or anything that allows it to be tracked when directly or indirectly coupled to or otherwise in communication with the device 102. The reader 104 may register and update the locations of multiple RFID devices 102 during their movement by communicating with an inventory management system, database, or the like.

The location of these RFIDs devices 102 can be determined from the RFID readers 104 in a variety of ways, for example, from signal strength (RSSI) at the receiving RFID readers 104. In some embodiments, multiple RFID readers 104, or at least one RFID reader with multiple antennas are placed at known locations of the environment, such as the entrance to a building, to estimate the position of the tag based on one or more of the distance between the reader 104 and the tag 102, e.g., using signal strength or time-of-flight methods, time-of-flight, phase angle, or the like described herein, the relative position of multiple readers 104, e.g., triangulation, and/or the known reader positions. AoA, while not providing distance, can provide a direction or angle from the reader. During a signal exchange, the reader 104 can estimate or infer each device's position based of the strength or time-of-flight methods, etc., and use the calculated position information of the device 102 to perform such an estimation or inference of the measurement of the signal such as RSSI.

Thus, although the RFID exchange alone may not directly provide the position of an RFID device 102, a combination of multiple readers, known locations, and/or additional techniques to pinpoint the position of the device. in real-time.

In embodiments, where the AoA of the reflected signal is used, the RFID reader(s) 104 will periodically broadcast to each of the RFID devices 102 in the environment. When performing the localization of a tag or other RFID device having multiple antennae or an antenna array to detect AoA, the RFID antennae scan the objects tagged with an RFID device 102 in a 2D space to estimate the coordinate of each tag from the reader's multiple antennae or antenna array, then using the RF waves' phase values at each antenna as received from the RFID devices 102, it estimates the object's orientation, i.e., the RFID device 102 is attached is the object, to determine the object's coordinates.

As the tag ID and position are established on the RFID devices 102, the computer vision system, which may include surveillance cameras 106 in the environment, for example, distributed throughout the area tracking the RFID devices 102, will determine a true position of each RFID device 102, e.g., as compared to the position provided during the exchange between RFID device 102 and reader 104, and correlate that position with the RF two dimensional (2D) position information determined by the RF reader 104 during a radio tracking operation, for example, determined from signals from the tag(s) 102 used for computing angles or the like of the tag 102 with respect to the reader(s) 104. By using the image of the space and the individual items that move and are stored in the space, the computer vision camera(s) 106 can register an image of an item in the space with an RFID tag that was registered and tracked by the RFID readers, registering the image in the camera's field of view (FOV) with the most likely RFID tag 102 correlated with that image (correlated from the RFID label location information provided by the RFID readers). In preferred embodiments, the tag 102 is a passive tag. In other embodiments, the tag 102 is an active RFID tag or a BLE tag.

For example, the camera 106 provides an FOV focused on a particular area of a tracked volume, or 3D view of a region in which one or more RFID devices 102 are positioned, i.e., stationary and/or in motion, or a region at which the holding the RFID devices 102 are located. For example, the FOV can include the “total” field of view of the camera 106 and region is the region of interest. Once the RFID label position is established by the RFID readers 104 and that location information is shared with the camera 106, the camera 106 can then continue to monitor the position of the RFID device 102 as it moves, i.e., tracked, and is “seen” by the camera 106.

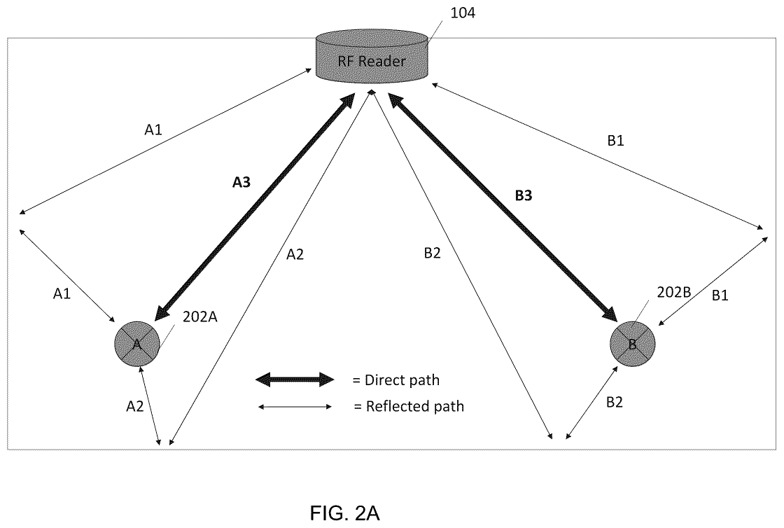

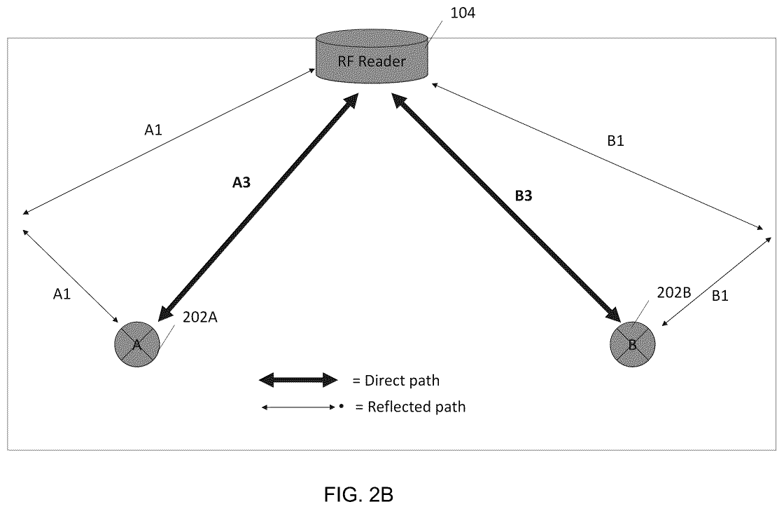

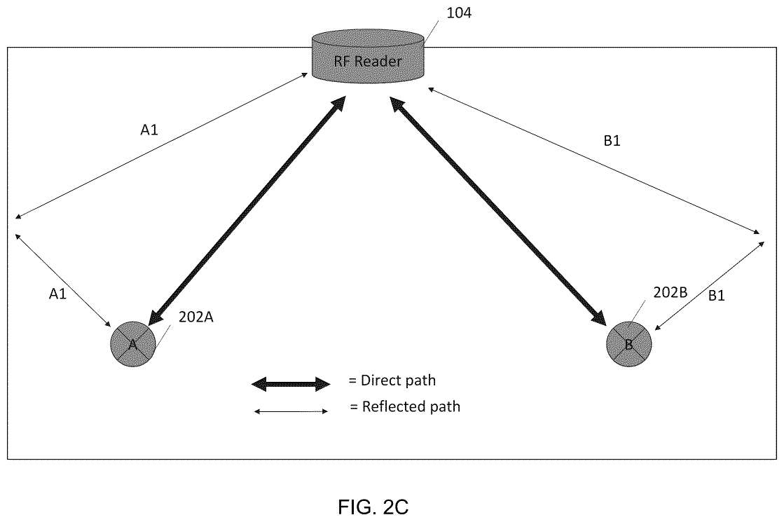

In doing so, the reader 104 sends a signal to the device antenna(s), which may include multiple beams of RF waves. For example, as shown in FIGS. 2A-2C, which illustrate a top view of the reader 102 and two RFID devices 102 in FIG. 1, an RFID label has an antenna (A) 202A and another RFID label has an antenna (B) 202B. In some embodiments, antennas 202A and 202B are part of two different ETDs. As shown, the reader antenna sends waves on several different paths. Each path besides the direct path (A3) is at a small angle from the center and has a high probability of experiencing reflection, refraction, diffraction or absorption depending on the materials or objects in the vicinity. That poses a problem in environments where there are multiple RFID tags in the read field, and where it is desirable to identify and localize tags of interest, for example, in a tag array. Conversely, the device's reflected or transmitted (in the case of an ETD) signal will be sent on multiple paths (see FIGS. 2A-2C), further adding interference and multipath signal propagation.

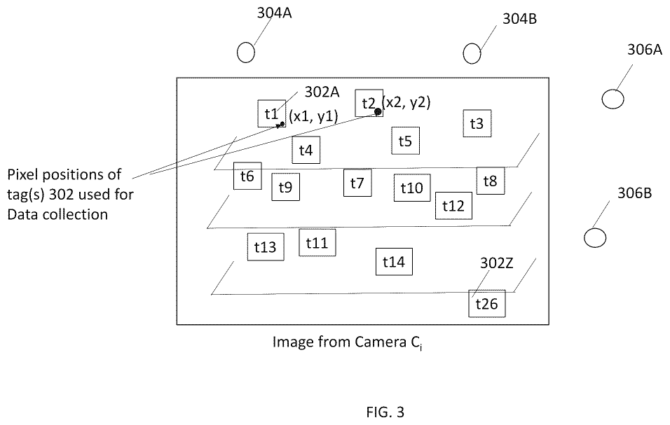

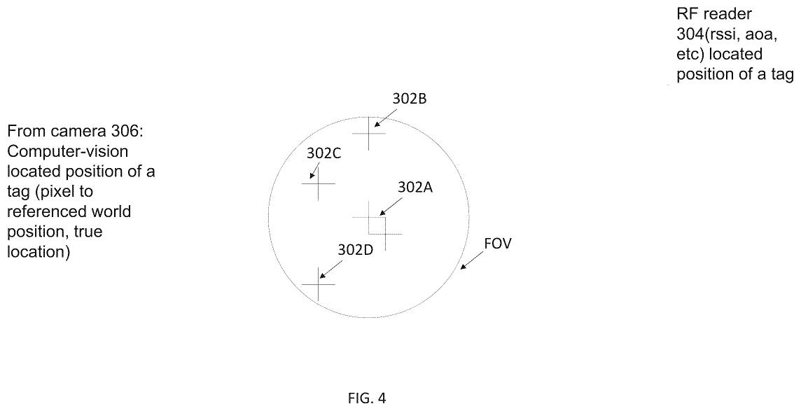

FIG. 3 illustrates a computer vision system that mitigates this problem by executing a calibration routine of a computer vision system to identify the two-dimensional (2D) or three-dimensional (3D) position of all of the RFID tags 302A-302Z (generally, 302) in the environment. The system can include one or more RFID tags 302, beacons 304, also referred to as radio network readers or RFID reader antennae, and cameras 306. Although tags 302 are shown, other RFID devices such as labels or other ETDs may equally apply. As shown in FIG. 4, a computer vision camera 306 can produce the true position (x, y, z) in a referenced coordinate system from a set of data, include the image pixels (x,y) corresponding to a RF tag 302, and the camera intrinsic and extrinsic parameters. Using this position-determination capability, the computer vision system finds the location of each of the plurality of the tags 102 in a three-dimensional coordinate system. In some embodiments, additional depth data allows data collection by the computer vision system from a set of data points across the field of view without being constrained to a single plane. In some embodiments, a camera 306 including a depth sensor (not shown) allows for measuring distance to those objects or persons within the field of view. When the depth sensor is included with a camera 306, a mapping operation may be performed by the camera 306 to calibrate the fields of view of the depth sensor and the camera 306 relative to each other so that a measured distance to an object or person is with respect to the camera's field of view. In other embodiments, color-related data (RGB) is collected from the tags, or marker on the tag or object, where multiple camera can be stitched together for mapping the environment. In some embodiments, one or more vision sensors include depth sensors that capture 3D spatial data of the environment to refine position estimation. Regardless of collected data type, e.g., RSSI, AoA, RGB, depth, and so on, the system builds a database of measurement data for calibration and training purposes.

For example, training a machine learning model to calibrate a computer vision camera 306 requires the model to estimate the camera's intrinsic parameters, such as focal length, distortion coefficients, principal point, and skew, by analyzing images of a structured pattern arrangement of tags 302 captured from multiple angles and positions. This process enables automatic correction for lens distortions and improves the accuracy of distance measurements in real-world scenes. A convolutional neural network (CNN) or a vision transformer (ViT)-based model can be trained on a large dataset of calibration images labeled with corresponding ground truth parameters. These models learn the relationships between pixel coordinates in the image and their corresponding 3D world coordinates by leveraging feature extraction, homography estimation, and depth perception techniques. A differentiable rendering approach or geometric deep learning can further refine the model's ability to correct for distortions and align camera views to a unified coordinate system.

Once the camera calibration is established, the system can use computer vision techniques such as multi-camera triangulation, structure from motion (SfM), and bundle adjustment to track the position of electronic tag devices (ETDs) across multiple camera views. The detected ETD positions are mapped to a common reference frame, ensuring that all tracked objects exist in a unified 3D space. This mapping simplifies the process of predictive signal correction in a complex system with multiple cameras and a large operational area.

To further enhance tracking and signal calibration, a graph neural network (GNN) or spatiotemporal transformer model can be used to learn relationships between ETD positions, radio receiver placements, and signal characteristics. The model's training dataset consists of ETD positions extracted from camera frames, the location and orientation of radio receivers, and the measured signal parameters (e.g., RSSI, AoA, ToA, TDoA) corresponding to each ETD. The model can be trained using supervised learning with labeled datasets of known ETD positions and signal measurements or semi-supervised/self-supervised learning to adapt to dynamic environments with minimal manual labeling. Recurrent architectures such as LSTMs or transformer-based sequence models can be incorporated to capture temporal variations in signal strength due to occlusions, motion-induced Doppler shifts, or environmental changes.

During inference, the trained model receives real-time ETD positions from the computer vision system and raw signal measurements from the radio tracking system. It then applies learned corrections, compensating for multipath interference, occlusions, and environmental noise, to predict the corrected signal strength for each ETD. This allows the system to make more accurate positioning estimates, reducing errors caused by non-line-of-sight (NLoS) conditions and improving tracking reliability across large, cluttered environments such as warehouses, industrial sites, or smart delivery vehicles.

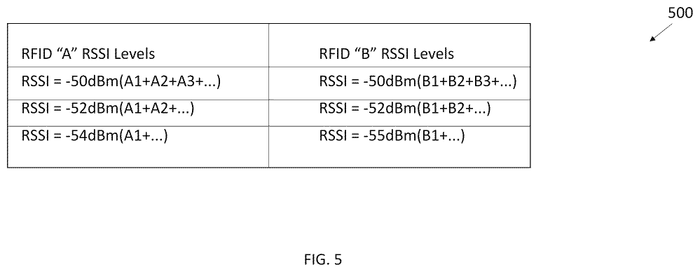

In some embodiments, the calibration routine performed by the system 300 of FIG. 3 can process the electromagnetic signals received by the reader from the RFID tags 302, including backscatter signals and the like, and generate a table 500 shown in FIG. 5, that arranges the multipath signals so that desired signals (i.e., direct path) are distinguished from reflected path signals. Because of the multipath, the RFID reader will receive RF signals included in a multipath signal so the measurement data (e.g., RSSI shown in FIGS. 2A-2C and 5, but not limited thereto) will be varied, which may result in errors in in this case the location of the desired tag 302 can be determined. Although the table 500 in FIG. 5 illustrates three different RSSI readings received by a receiver, a typical exchange may include hundreds or thousands of readings that can be processed to distinguish direct paths from reflected paths. As previously stated, other embodiments can pertain to measurements other than RSSI, such as AoA and so on.

The RSSI levels imply distance from a RFID device to the RF reader 304 for a combination of the signal paths, shown in FIGS. 2A-C and 4. In FIGS. 2A-5, the RFID labels (A, B) have multiple possible paths (A1, B1, etc.). However, in actual operating environments, the number of multiple signal paths (multipath) of transmitted signals from RFID labels (or other transmitting devices) could be in the hundreds or more, and changes frequently. Determining range or, more specifically, the correct direct signal, is a challenge. As shown in FIG. 3, using computer vision, namely, the cameras 306, can help establish a position of an RFID tag 302, label, or the like and correlate that position with the most direct path signal, e.g., A3, B3, helping the system cancel out the multipath signals, e.g., shown in FIGS. 2A-2C, that would normally imply multiple ranges of the RFID device to the RF reader, for example, a range derived from the direct path corresponding to a current position of the label.

Referring again to FIG. 3, and further referring to FIG. 4, the collection and processing of signal data can apply to all RFID tags 302 or other ETDs in the environment. The calibration routine of the computer vision system can identify a 2D or 3D position of all tags 302 so that the position of the tags 302 can be calibrated to the image of the RFID tags captured by one or more computer vision cameras 306. From this data collected and processed for all RFID tags 302, a model of the environment can be created and referenced against the multiple RF signals received at the RF reader, via its antenna(s) 304 to establish the correct true direct signal between the tag 302 and the reader, or more specifically, its multiple antennae 304.

In some embodiments, shown in FIGS. 3 and 4, the computer vision system can establish the 2D or 3D position of all tags 302, either manually or automatically. In some embodiments, markers may be used. In other embodiments, the markers may be affixed to or otherwise part of the tags 302, which may include barcodes, QR codes, or other identification information for the computer vision system to identify the tag or marker. In other embodiments, tags' identity information can be entered manually to a user interface or the like that is part of a computer system (not shown) that can exchange information with the various elements of the system, e.g., reader, cameras, etc. This identify information can be used to recalibrate the 2D or 3D position of the RFID tags 302 to the image of the tags captured by the computer vision camera or cameras. As shown in FIGS. 3 and 4, the RGB pixel position data (i.e., xyz positions) from the computer vision camera(s) and the RF values (via RSSI, AoA, TDoA, or other electromagnetic signal) from the reader can be provided to an algorithm executed by a special purpose processor of the computer system.

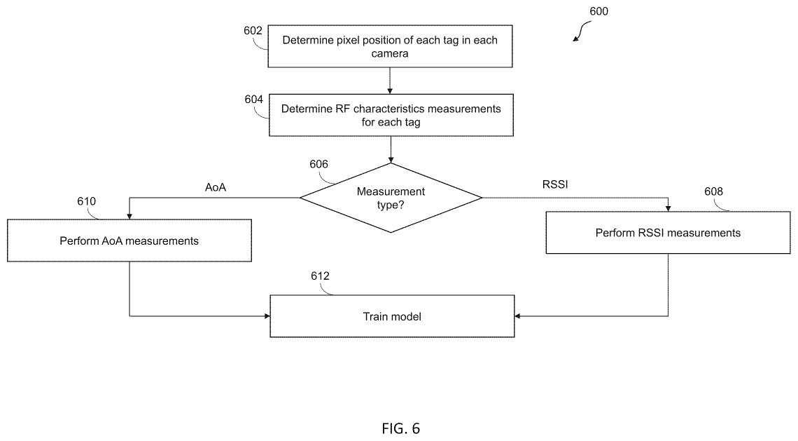

FIG. 6 is a flow diagram of a method for calibration, in accordance with some embodiments. In describing the calibration routine 600, reference is made to some or all of FIG. 3. Shown in FIG. 3 is a plurality of electronic tags positioned at a set of shelves. Although tags are shown, markers (e.g., barcode, QR codes, etc.) or other identifiers for detection by computer vision cameras may equally apply. Although 26 tags (t₁-t₂₆) are shown, any number of tags can equally apply. The calibration routine 600 may be executed by a special-purpose computer processor, for example, used in FIGS. 3 and 4 for calibrating a position tracking system used to track a physical location of a radio frequency (RF) transmitter of each of a plurality of electronic ETDs, such as RFID tags, labels, or the like.

Each tag has a pixel position. In this example, there are 26 tags of interest. Here each tag(tᵢ), where i=1-26, has a pixel position. In some embodiments, the pixel position has two dimension (x, y) coordinates. For example, tag t₁ has a pixel position (x₁, y₁), tag t₂ has a pixel position (x₂, y₂), and so on. In other embodiments, each tag has a three dimension (x, y, z) coordinate position. The pixel position(s) of the tag(s) are collected as data for subsequent processing.

At step 602, the pixel position for each tag is determined for each camera. In this example, there are two cameras (Cⱼ), where j=2. The pixel position in each camera may be determined by: Cⱼ=[((x₁, y₁), . . . (x₂₆, y₂₆)]. This array of tag locations in the camera image is referred to as [Locsⱼ]. For each camera (Cⱼ), each tag has a location [Locsᵢ], such that Cᵢⱼ refers to the pixel position for each tag for each camera.

At step 604, the RF characteristics measurements of each tag is determined, which at decision diamond 606, is dependent on the type of measurement. If the measurement is an RSSI measurement, then at step 608, then beacon measurements are collected for each beacon (Bk), where k refers to the number of beacons, in this example, 2 beacons, or RF readers. For each tag, beacon measurements are taken, or Mᵢₖ, where i refers to the tags and k refers to the beacons. Thus, an association is made between the tags and the beacons, and for each beacon, RSSI measurements are determined with respect to each tag, namely, t₁->RSSI₁ through t₂₆->RSSI₂₆. The resulting measurements are [RSSI₁, RSSI₂ . . . . RSSI₂₆].

If at decision diamond 606, the measurement type is an angle of arrival (AoA) measurement type, then the calibration routine 600 proceeds to step 610. As is well-known, AoA calculations include elevation and azimuth measurements for each tag, or Eᵢ, Aᵢ, respectively. Here, the AoA measurements are identified as [E₁, A₁, E₂, A₂, . . . . E₂₆, A₂₆]. In cases where there are multiple beacons, e.g., RF readers, etc., then for each beacon, the above can be applied for each beacon, or for Beacon k, Bₖ=[E₁, A₁, E₂, A₂, . . . E₂₆, A₂₆]. Referring again to decision diamond 606, although RSSI and AoA are described, other tracking technologies may equally apply. Such technologies may be used instead of steps 608 and 610. At step 612, a model or equation can be trained with the output of step 608 or 610.

In some embodiments, a linear regression model can be trained, where:

$${C}_{ij} = {}^{k} {\sum }_{k = 1} = {W}_{jk} * {M}_{ik} + {b}_{jk} ,$$

where i is the number of tags, j is the number of cameras, and k is the number of beacons. W and b are the trained factor matrix and bias

In other embodiments, a polynomial regression model can be trained, where beacon measurements are determined as: Mᵢ=[Mᵢ₁, Mᵢ₂ . . . Mᵢ₂₆] for pixel positions Pij=[xⱼ], yⱼ].

For each camera, Cⱼ:

$${x}_{j} = {f}_{x} ( {M}_{i} ) = {B}_{x , 0} + {}^{k} {\sum }_{k = 1} {B}_{xk} {M}_{ik} + {}^{k} {\sum }_{k = 1} {}^{k} {\sum }_{l = 1} {B}_{xkl} {M}_{ik} {M}_{il} + …$$

$${y}_{j} = {f}_{y} ( {M}_{i} ) = {B}_{y , 0} + {}^{k} {\sum }_{k = 1} {B}_{yk} {M}_{ik} + {}^{k} {\sum }_{k = 1} {}^{k} {\sum }_{l = 1} {B}_{ykl} {M}_{ik} {M}_{il} + …$$

Mi can be extended to include polynomial terms (linear, quadratic, and so on).
φⱼ (Mᵢ)=[1, M_{φ1}, M_{φ2}, . . . . Mᵢₖ, M²_{φ1}, . . . , Mᵢ₁, Mᵢ₂+ . . . ], to arrive at the following regression equations: xj=φⱼ(Mᵢ) Bₓ and yj φⱼ(Mᵢ) B_{y}, where Bₓ and B_{y} are learned.

In other embodiments, machine learning models such as RandomForest, GradientBoosting, etc. may be applied, for example, using (Mᵢ, Cᵢⱼ). Furthermore, techniques listed above could be employed to leverage state of the art deep learning techniques to handle multiple readers, cameras and complex environments.

Accordingly, new tags or changes in tag position or arrangement shown in FIG. 3 after the calibration process is completed can be processed by the routine 600. In sum, computer vision is implemented to provide fixed points for reference to qualify and screen RF signals, multipath, improve the RF signal quality and characterize a location (such as a room, shelf, and so on) having a multipath environment.

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure, or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, inner, and outer, interior, and exterior, and vertical and horizontal are intended for convenience of description, not to limit the described systems and methods or their components to any one positional or spatial orientation. Accordingly, the foregoing description and drawings are by way of example only, and the scope of the invention should be determined from proper construction of the appended claims, and their equivalents.

What is claimed is:

1. A system for tracking an object, comprising:
an electronic tag device (ETD) affixed to the object;
one or more readers that receive signal measurements from the electronic tag device (ETD);
one or more vision sensors that track the object and generate a location of the object in the image data representing a position of the at least one electronic tag device (ETD) and/or the object in a field of view; and
a special-purpose processor that receives the signal measurements and the image data and applies a calibration algorithm to predict an accurate signal measurement adjusted based on the location of the object, wherein the special-purpose processor further determines a true position from the image data and correlates the true position with the signal measurements received by the one or more readers to refine the position estimation of the electronic tag device (ETD).

2. The system of claim 1, wherein the at least one electronic tag device includes a plurality of passive radio frequency identification (RFID) tags and the reader includes an RFID reader processor in communication with an antenna that receives the signals from the RFID tags.

3. The system of claim 1, wherein the at least one electronic tag device includes a plurality of passive radio frequency identification (RFID) tags and multiple RFID readers with antenna arrays that receives the signals from the RFID tags and the special-purpose processor computes the position of the ETDs.

4. The system of claim 1, wherein the one or more vision sensors includes at least one depth sensor.

5. The system of claim 1, wherein the at least one electronic device includes a plurality of Bluetooth low energy (BLE) tags.

6. A method for calibrating a system for tracking an object, comprising:
capturing signal measurements from an electronic tag device (ETD) at each position of a plurality of positions;
applying a calibration routine to generate a dynamic signal response model based on position-dependent variations of the plurality of positions;
capturing signal measurements affected by multipath interference and noise;
comparing the operational signal measurements to the dynamic signal response model to generate environmental correction factors; and
applying the correction factors to refine future signal measurements when tracking objects.

7. The method of claim 6, wherein the positions are predefined positions.

8. The method of claim 6, wherein the electronic tag device (ETD) has a GPS or location software for determining the positions.

9. The method of claim 6, wherein the positions are determined by tracking using vision-based technology.

10. The method of claim 6, wherein the electronic tag device (ETD) is part of a set of electronic tag devices (ETDs), and wherein the method comprises:
positioning the set of electronic tag devices (ETDs) in a structured calibration grid at predefined locations around one or more readers in a controlled, noise-free environment;
capturing initial signal measurements from the ETDs using the one or more readers;
applying the calibration routine to establish baseline signal characteristics for each ETD position;
relocating the calibration grid to an operational environment;
capturing new signal measurements from the ETDs in the operational environment; comparing the operational signal measurements to the baseline signal characteristics to model environmental effects such as multipath interference and noise; and
using the modeled environmental effects to generate correction factors for refining future signal measurements received by the one or more readers when tracking objects.

11. The method of claim 10, wherein the electronic tag devices (ETDs) are passive RFID tags, and the one or more reader(s) are RFID readers with a single antenna measuring received signal strength (RSSI).

12. The method of claim 10, wherein the one or more readers have antenna arrays and measure the angle of arrival (AoA) of the signals received from the electronic tag devices (ETDs).

13. The method of claim 10, wherein the electronic tag devices (ETDs) are Bluetooth Low Energy (BLE) beacons.

14. The method of claim 6, further comprising:
moving the electronic tag device (ETD) through predefined positions around one or more readers in a controlled, noise-free environment; capturing signal measurements from the electronic tag device (ETD) at each position using the one or more readers;
applying the calibration routine to generate a dynamic signal response model based on position-dependent variations;
repeating the movement of the electronic tag device (ETD) in an operational environment;
capturing signal measurements affected by multipath interference and noise;
comparing the operational signal measurements to the dynamic signal response model to generate environmental correction factors; and
applying the correction factors to refine future signal measurements when tracking objects.

15. The method of claim 14, wherein the one or more vision sensors track the movement of the electronic tag device (ETD) and map its position to a reference coordinate system to improve calibration accuracy.

16. The method of claim 14, wherein the one or more readers are RFID readers with a single antenna measuring received signal strength (RSSI).

17. The method of claim 14, wherein the one or more readers have antenna arrays and measure the angle of arrival (AoA) of the signals received from the electronic tag device (ETD).

18. A method for calibrating a system for tracking an object in an operational environment with occlusions, comprising:
capturing baseline signal measurements from electronic tag devices (ETDs) in an environment without obstructions;
capturing additional signal measurements while introducing occluding objects such as humans or robots in the environment;
determining deviations in signal characteristics caused by occlusions;
applying a modeling technique to learn occlusion-induced signal distortions based on occluder positions and movements; and
generating correction factors that dynamically adjust future signal measurements based on detected occlusions.

19. The method of claim 18, wherein one or more vision sensors detect the presence and location of occluding objects in real time and use this data to apply occlusion-aware signal corrections.

20. A method for calibrating a system for tracking an object using multiple vision sensors and multiple readers, comprising:
capturing signal measurements from electronic tag devices (ETDs) using multiple readers;
capturing positional data of the ETDs using multiple vision sensors;
mapping each ETD's pixel coordinates in the vision sensors to a shared reference coordinate system;
collecting signal measurements from each reader in relation to the known positions of the ETDs;
training a machine learning model with the ETD positions and corresponding signal measurements to learn relationships between environment-induced distortions and expected signal behavior; and
using the trained machine learning model to predict corrected signal measurements in real-time during tracking operations.

21. The method of claim 20, wherein the one or more vision sensors include depth sensors that capture 3D spatial data of the environment to refine position estimation.

22. The method of claim 20, wherein the machine learning model is a graph neural network (GNN) trained on signal strength (RSSI), angle of arrival (AoA), and time difference of arrival (TDoA) features to learn the environmental distortions affecting signal propagation.

23. The method of claim 20, wherein the machine learning model is a transformer-based spatiotemporal model trained on historical signal measurements and ETD positions to dynamically adjust position calculations based on real-time data.
